(19) United States
(12) Patent Application Publication
(10) Pub. No.: US 2016/0239846 A1
(43) Pub. Date: Aug. 18, 2016

(54) Payment Networks and Methods for Processing Support Messages Associated With Features of Payment Networks

(71) Applicant: MASTERCARD INTERNATIONAL INCORPORATED, Purchase, NY (US)

(72) Inventors: Ravi Santosh Arvapally, O'Fallon, MO (US); Walter Lo Faro, Chesterfield, MO (US); Jeffrey Gordley, Lake St. Louis, MO (US); Craig Borgmeyer, Wentzville, MO (US)

(21) Appl. No.: 14/620,731

(22) Filed: Feb. 12, 2015

(51) Int. Cl. G06Q 30/00

(52) U.S. Cl. CPC G06Q 30/016

(57) ABSTRACT

Networks and methods are provided for processing support messages related to one or more features of a payment network. In connection therewith, a support message is initially received from a customer of the payment network, including text related to an issue encountered by the customer with one or more features of the payment network. The text of the support message is normalized, and a score vector is assigned to the normalized support message. The score vector is indicative of a number of occurrences of multiple words in the normalized support message. A response message for the support message is then identified, based on the score vector, and transmitted to the customer.

### FIELD

The present disclosure generally relates to payment networks and methods for processing support messages related to features of the payment networks, from customers of the payment networks, and providing response messages to the customers.

### BACKGROUND

This section provides background information related to the present disclosure which is not necessarily prior art.

Payment accounts are known for supporting transactions for goods and services. These transactions are completed between entities associated with the payment accounts and entities associated with the goods and/or services to be purchased. The entities are connected through a payment network, through which the transactions are completed. When the entities along the payment network experience one or more issues with the payment network, a support request is sent to one or more entities associated with the payment network. Customer service personnel then respond to the support requests in order to resolve the issues with the payment network.

### DRAWINGS

The drawings described herein are for illustrative purposes only of selected embodiments and not all possible implementations, and are not intended to limit the scope of the present disclosure.

FIG. 1 shows an exemplary payment network including one or more aspects of the present disclosure;

FIG. 2 is a block diagram of an exemplary computing device, suitable for use in the payment network of FIG. 1;

FIG. 3 is a flowchart of an exemplary method for processing a support message received from a customer, which can be implemented via the payment network of FIG. 1;

FIG. 4 illustrates an example progression for normalizing a support message received from a customer, according to the exemplary method of FIG. 3; and

FIG. 5 illustrates an example word matrix for the normalized support message of FIG. 4.

Corresponding reference numerals indicate corresponding parts throughout the several views of the drawings.

### DETAILED DESCRIPTION

When issues arise with a payment network (e.g., with features of the payment network, etc.), customers of the payment network (e.g., consumers, merchants, issuers, acquirers, etc.) send support messages (e.g., electronic messages or emails, etc.) to entities associated with the payment networks,(e.g., customer service personnel associated with the entities, etc.) seeking assistance or resolution of the issues. Depending on the size of the payment network, the number of customers associated with the payment network, and/or the number of features associated with the payment network, a volume of support messages received at the entities associated with the payment network may be substantial, e.g., thousands per day, etc. With that said, the payment networks and methods described herein help facilitate processing of the incoming support messages from the customers, to efficiently provide response messages to the customers (in response to the support messages). In particular, the payment networks and methods, among other things, uniquely normalize and score the support messages, and then use the scores, in combination with scores for historical messages, to identify appropriate response messages for transmittal to the customers.

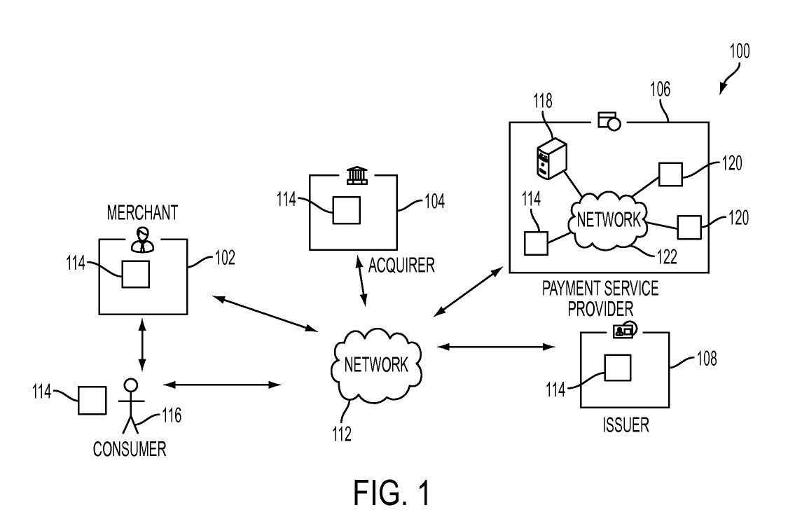

FIG. 1 illustrates an exemplary payment network 100, in which the one or more aspects of the present disclosure may be implemented. Although components of the payment network 100 are presented in one arrangement, other embodiments may include the same or different components arranged otherwise, depending, for example, on processing of payment account transactions, etc.

The illustrated payment network 100 generally includes a merchant 102, an acquirer 104, a payment service provider 106, and an issuer 108, each coupled to network 112. The network 112 may include, without limitation, one or more local area networks (LAN), wide area networks (WAN) (e.g., the Internet, etc.), mobile networks, virtual networks, other networks as described herein, and/or other suitable public and/or private networks capable of supporting communication among two or more of the illustrated components, or even combinations thereof. In one example, network 112 includes multiple networks, where different ones of the multiple networks are accessible to different ones of the illustrated components in FIG. 1. In this embodiment, each of the merchant 102, the acquirer 104, the payment service provider 106, and the issuer 108 include a computing device 114 coupled to the network 112. Each computing device 114 may include a single computing device, or multiple computing devices located together and/or distributed across a geographic region.

The payment network 100 further includes a consumer 116, who transacts with the merchant 102 for the purchase of goods and/or services. Transactions may occur in-person at a location associated with the merchant 102, or remotely via telephonic, network, or other connections between the merchant 102 and the consumer 116 (e.g., via network 112, etc.). In this example embodiment, the consumer 116 is also associated with a computing device 114. While only one merchant 102, acquirer 104, issuer 108, and consumer 116 are shown, a different number of one or more of these entities may be included in other embodiments. For purposes of the description herein, each is referred to as a “customer” of the payment network 100, and the payment service provider 106. More generally, exemplary payment networks and methods are described herein with reference to the payment service provider 106 for purposes of illustration. However, the methods and payment networks herein may be employed in other entities, or other parts, of a payment network in other embodiments.

In the payment network 100, the merchant 102, the acquirer 104, the payment service provider 106, and the issuer 108 cooperate to process a request from the consumer 116 to complete a payment account transaction with the merchant 102, via a payment device (e.g., a credit card, a debit card, a pre-paid card, a payment token, a payment tag, a pass, another device used to provide account information (e.g., a smartphone, a mobile application, a tablet, etc.) etc.). In the exemplary embodiment, the consumer 116 initiates the transaction by presenting a credit card to the merchant 102. In such a credit transaction, for example, the merchant 102 reads the credit card and communicates the associated account information, the amount of the purchase, and/or other information to the acquirer 104 to determine whether sufficient credit exists to complete the transaction.

The acquirer 104, in turn, communicates with the issuer 108, through the payment service provider 106 (and the network 112), for authorization to complete the payment account transaction. If the issuer 108 accepts the transaction, an authorization response is provided back to the merchant 102 and the merchant 102 completes the transaction. The credit line of the consumer 116 is altered by the amount of the transaction, and the charge/credit is posted to the account associated with the credit card. The transaction is later cleared and/or settled by and between the merchant 102 and the acquirer 104, and by and between the acquirer 104 and the issuer 108. Debit and pre-paid payment device transactions are substantially similar to the above, but, in some examples, may further include the use of a personal identification number (PIN) authorization and more rapid posting of the charge/credit to the account associated with the device, etc.

Each payment account transaction, and its communication through the merchant 102, the acquirer 104, the payment service provider 106, and the issuer 108, whether complete or not, involves one or more features of the payment network 100. Regardless of whether the features are available at the issuer 108, the consumer 116, the acquirer 104, or the payment service provider 106, the features often are associated with and/or provided by the payment service provider 106. In general, such features may relate to authorization of transactions, clearing of transactions, settlement of transactions, data access, document retrieval, chargebacks, reporting, security (or fraud), or any other features associated with the payment network 100 (or with one or more other payment networks), etc. However, it should be appreciated that several different features may be associated with the different processes, for which the payment network 100 may be utilized. As an example, the features may relate to a digital wallet associated with the payment service provider 106 (and the issuer 108), which is usable by the consumer 116. As another example, the features may relate to the flow of transaction data between the acquirer 104 and the issuer 108, through the payment service provider 106 for authorization, settlement, and other processing of transactions (e.g., features supported by MasterCom™ systems, etc.).

With continued reference to FIG. 1, the payment service provider 106 includes a support engine 118. The support engine 118 is a computing device, which may be a single computing device, or multiple computing devices located together and/or distributed across a geographic region. As shown, in this exemplary embodiment, other computing devices 120 are included in communication with the support engine 118 (and with the computing device 114), via a network 122. The computing devices 120 may include a computing device associated with customer support personnel, located together and/or distributed across a geographic region, etc. In addition, the network 122 may be a part of network 112, or separate therefrom, and may include, without limitation, a local private intranet, a local area network (LAN), a wide area private network, a wide area public network (e.g., the Internet, etc.), a mobile network, and/or another suitable network capable of supporting communication between the support engine 118 and the network 112 (and/or computing devices 114 and 120).

Each computing device 114, 118 and 120 in the system may include, without limitation, a server (e.g., an application server or web server, etc.), a desktop computer, a laptop computer, a workstation computer, a personal computer, a tablet computer (e.g., an iPad™, a Samsung Galaxy™, etc.), a handheld computer or other communication device (e.g., a netbook, a specialized reservation device, etc.), a smart phone (e.g., an iPhone™, a BlackBerry™, a HTC™ phone, etc.), the like, or combinations thereof.

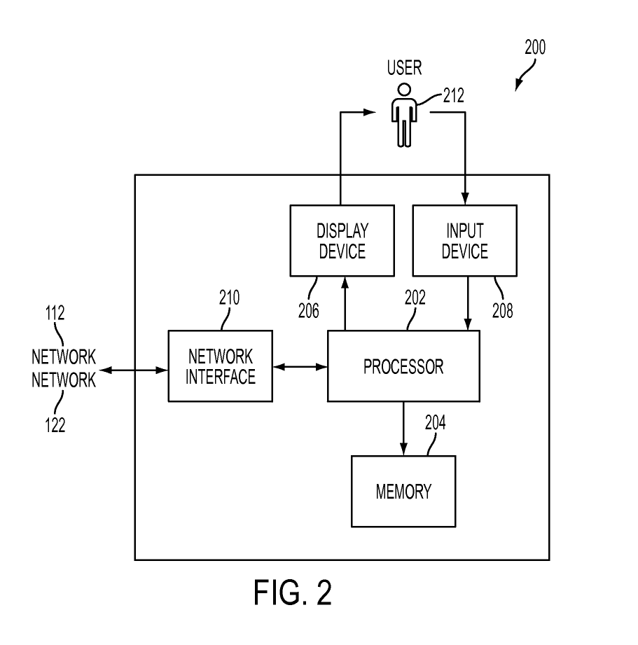

FIG. 2 illustrates an exemplary computing device 200. For purposes of the description herein, each of the computing devices 114, 118 and 120 shown in FIG. 1 is a computing device, consistent with computing device 200. However, it should be appreciated that the computing devices 114, 118, and 120 of FIG. 1 should not be understood to be limited to the arrangement of the computing device 200, as depicted in FIG. 2. Different components and/or arrangements of components may be used in other computing devices. In various embodiments, the computing device 200 includes multiple computing devices located in close proximity, or distributed over a geographic region.

The exemplary computing device 200 includes a memory 204 and a processor 202 that is coupled to memory 204. Processor 202 may include one or more processing units (e.g., in a multi-core configuration, etc.). Computing device 200 is programmable to perform one or more operations described herein by programming the memory 204 and/or processor 202. Processor 202 may include, but is not limited to, a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

Memory 204, as described herein, is one or more devices that enable information, such as executable instructions and/or other data, to be stored and retrieved. Memory 204 may include one or more computer-readable media, such as, without limitation, dynamic random access memory (DRAM), static random access memory (SRAM), a solid state disk, and/or a hard disk. Memory 204 may be configured to store, without limitation, support messages, reference support messages, response messages, predefined lists of words, etc. In this embodiment, the memory 204 includes a set of score vectors, each associated with a reference support messages and/or a response message. The score vectors in memory 204 are, for example, determined according to the methods described herein, for use in identifying, by the processor 202, a response message for a given support message.

In the exemplary embodiment, computing device 200 includes a display device 206 that is coupled to processor 202. Display device 206 outputs to a user 212 by, for example, displaying and/or otherwise outputting information such as, but not limited to, support messages, response messages, etc. Display device 206 may include, without limitation, a cathode ray tube (CRT), a liquid crystal display (LCD), a light-emitting diode (LED) display, an organic LED (OLED) display, and/or an “electronic ink” display. In some embodiments, display device 206 includes multiple devices. The user 212 may include the customer described herein, for example, the consumer 116, support personnel of the payment service provider 106, or an employee or affiliate of other entities shown in FIG. 1, etc.

In the exemplary embodiment, computing device 200 further includes an input device 208 that receives input from the user 212, such as the customer described herein. For example, input device 208 may be configured to receive any desired type of inputs from the user 212, for example, as part of compiling and sending a support message, an agreement, etc. In the exemplary embodiment, input device 208 is coupled to processor 202 and may include, for example, a keyboard, a pointing device, a mouse, a stylus, a touch sensitive panel (e.g., a touch pad or a touch screen, etc.), and/or an audio input device. Further, in various exemplary embodiments, a touch screen, such as that included in a tablet or similar device, functions as both display device 206 and input device 208.

In the exemplary embodiment, computing device 200 also includes one or more network interface devices 210 coupled to processor 202. Network interface device 210 may include, without limitation, a wired network adapter, a wireless network adapter, a mobile telecommunications adapter, or other device capable of communicating to one or more different networks, including the network 112 and/or the network 122. In at least one embodiment, computing device 200 includes processor 202 and one or more network interface devices 210 incorporated into or with processor 202.

In further embodiments, computer-executable instructions are stored on non-transitory memory 204 for execution by processor 202 to perform one or more of the functions described herein. These instructions may be embodied in a variety of different physical or tangible computer-readable media, such as memory 204 or other non-transitory memory, such as, without limitation, a flash drive, CD-ROM, thumb drive, floppy disk, etc.

With continued reference to FIG. 1, when issues or problems arise with features of the payment network 100, the customer (whether the consumer 116, the acquirer 104, the issuer 108, or other customer) utilizes a computing device (e.g., computing device 114, etc.) to provide a support message (e.g., via email, etc.) to the payment service provider 106. Support messages are described in more detail below.

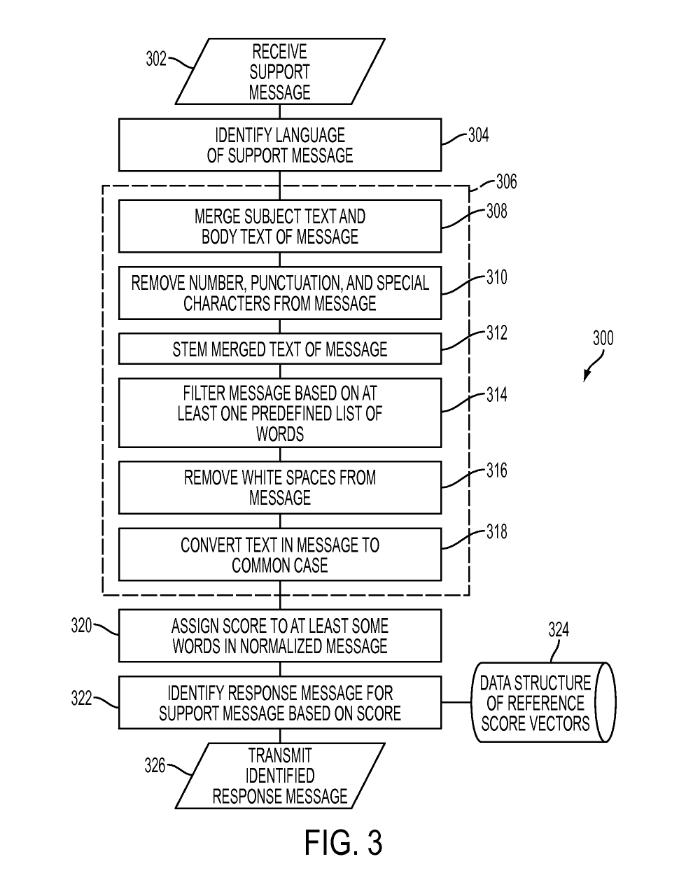

In response, the support engine 118 of the payment service provider 106 is configured to, among other things, receive the support message (and any other support messages related to the payment network 100), normalize the support message, assign a score vector to the normalized message, identify a response message based on the score vector, and transmit the response message back to the customer, from which the support message originated (and/or to another party, etc.). Specific configurations of the exemplary support engine 118 are further described below with reference to the exemplary method 300 of FIG. 3. It should be appreciated, however, that the method 300, and other methods described herein, are not limited to the exemplary payment network 100, or the computing device 200, but may be implemented in a variety of different systems and/or computing devices (e.g., other computing devices in the payment network 100, or another network). Likewise, the payment networks and computing devices described herein should not be understood to be limited to the exemplary method 300, or other methods described herein.

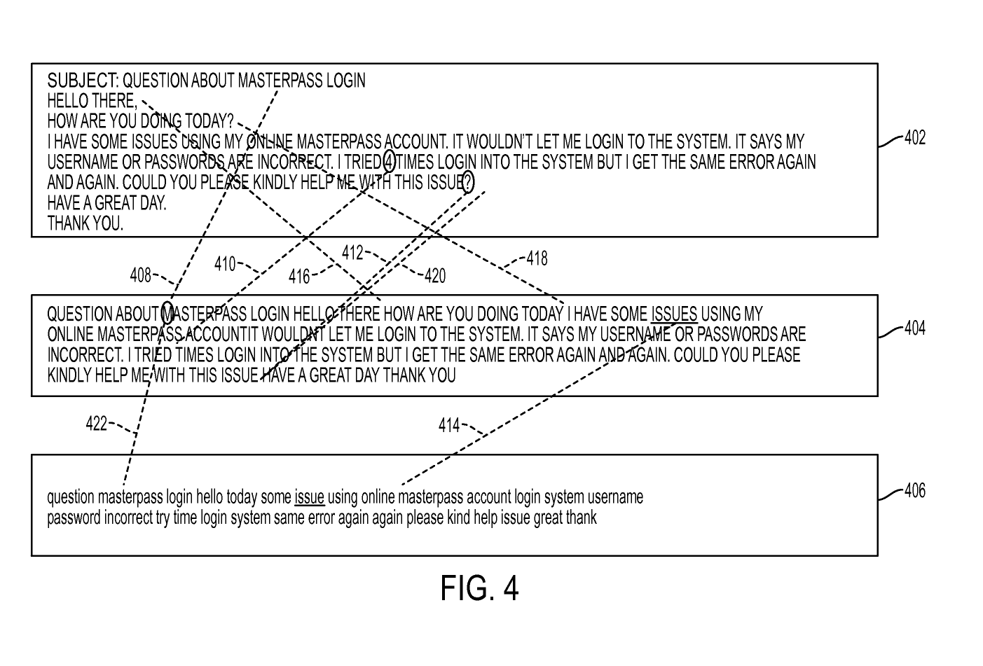

The method 300 is further described with reference to the exemplary support message 402 illustrated in FIG. 4. The support message 402, generically, is indicative of an issue being experienced by a customer of the payment network 100 and/or relates to a feature of the payment network 100. While the exemplary message 402 is an email and is provided by the customer in text, it should be appreciated that other types/forms of messages may be processed by the support engine 118 described herein, and/or according to one or more of the methods described herein. For example, support messages may be provided from customers in audible mediums (e.g., voicemails, etc.) or other mediums, which are then converted to text.

Referring to FIG. 3, the customer may initially send a support message (e.g., support message 402 in FIG. 4, another support message, etc.), when an issue or problem with one or more features of the payment network 100 is realized. Issues may include, for example, and without limitation, login errors, forgotten passwords, failed prepaid reloads, failed money transfers, lost/stolen cards, security token issues, “How do I” issues, declined transactions, data integrity issues, settlement errors, clearing errors, application-specific issues (e.g., related to MasterCard® inControl™ services, etc.) monitoring flags/alerts, etc. The support engine 118, in turn, receives, at 302, the support message from the customer. The support engine 118 may receive the support message in a variety of different ways depending on, for example, the format of the support message (e.g., email, voicemail, etc.) and/or the networks 112/122.

As an example, the support message may be an email from the consumer 116, including both subject text and body text, which is received via network 112. Further, the email may be received via a link listed on a webpage associated with the payment service provider 106, or via a webpage of another entity shown (or not shown) in FIG. 1. In addition in this example, if the consumer 116 experiences an issue with the merchant 102, or the issuer 108, for example, the consumer 116 may direct the support message to the merchant 102 or the issuer 108. The merchant 102 or issuer 108, or other may then send, or forward, the support message to the payment service provider 106 (and the support engine 118), as appropriate, for response. Alternatively, in some embodiments, possibly depending on the issue raised in the support message, the merchant 102 or issuer 108 may retain the support message and respond to the consumer 116 directly, either without forwarding the message to the payment service provider 106 or in parallel with forwarding the message to the payment service provider 106.

Next in the method 300, after receiving the support message from the customer, the support engine 118 identifies an original language associated with the message, at 304 (e.g., English, Spanish, German, Chinese, etc.). The support engine 118, after identifying the language, in this particular embodiment, either translates the message to a particular predetermined language (e.g., English, etc.), or processes the message, as described below, in its original language. In some embodiments, it may be preferred to convert to a single language, so that processing of the message is consistent regardless of its original language. In such embodiments, it is further preferred, although not required, to provide a response message, to the support message, in the same language as the original support message. In the example of FIG. 4, the support message 402 is in the English language, and is processed, as described below, in English.

The support engine 118 then normalizes the support message, at 306. The message is normalized to enable, in this embodiment, efficient processing of the message. As indicated by the broken lines in FIG. 3, multiple different normalization techniques are employed at 306 to normalize the message. It should be appreciated, however, that a different number of techniques may be included in other embodiments, with some of the techniques described herein included or omitted. In addition, the techniques indicated in FIG. 3, at 306, may be performed in the order illustrated, or in different orders as appropriate.

In connection with normalizing the support message, in this exemplary embodiment, the support engine 118 initially merges, at 308, subject text and body text of the message into a common text portion. As an example, in FIG. 4, the subject text and body text of the support message 402 are merged together, at 408 (and at other places), into a common text portion, represented by intermediate message 404. Next in the method 300, the support engine 118, in normalizing the message, removes, at 310, numeric characters, punctuation characters, and special characters from the support message. It should be appreciated, however, that number characters, punctuation characters, and/or special characters may be preserved in other embodiments. For example, if a particular special character, or punctuation character, is determined to be indicative of a certain issue, or solution, that character may be preserved, rather than removed, to improve the processing of the message. Again as an example, in FIG. 4, as shown in the intermediate message 404, the number character “4” is removed from the support message 402, at 410, and the punctuation character “?” is removed from the support message 402, at 412, among others.

At 312 in the method 300, the support engine 118 stems the merged text of the support message. In this exemplary embodiment, stemming includes replacing words with root terms, or particular forms of a word. As such, similar words (or words with similar or the same meanings) are not counted as different words in further steps of the method 300. For example, “running,” “ran,” and “run” are all forms of the word “run,” but are used in different contexts. Stemming, as used herein, causes “running” and “ran” to be replaced with the root term “run.” In the example of FIG. 4, as part of stemming, the word “issues” in the intermediate message 404 is replaced with the root word “issue,” at 414, in normalized message 406, essentially replacing the plural form of the word with the singular form as the root word (however, it should be appreciated that the singular form of words are not always the root words).

At 314 in the method 300, the support engine 118 filters the text of the support message based on words included in at least one predefined list of words.

The at least one predefined list of words may include a predefined stop list, which includes words to be “stopped” or removed from the support message. Words included in the predefined stop list are often frequently used, and thus may have limited potential to aid in the determination of the issue referenced/raised in the support message, or in the determination of a cause or solution to that issue. As can be appreciated, by removing words from the support message, as included in the predefined stop list, remaining words may be processed more efficiently. It should also be appreciated that the predefined stop list may be used, by the support engine 118, against all messages, i.e., it may be generic, or the predefined stop list may be specific to particular messages based on, for example, an origin of the message, pre-processing of the message, keyword searching within the message, a category of the message, etc. Further, it should be appreciated that a wide variety of words may be included, or excluded, from a predefined stop list, according to a variety of criteria. In the example of FIG. 4, the intermediate message 404 is filtered based on a predefined stop list that includes the words: about, there, I, have, and some (however, the list could include more, less, or different words). As such, in the normalized message 406, these terms are removed (as compared to the original support message 402 and the intermediate message 404 where they are included).

The predefined stop list of words may be compiled, by the payment service provider 106 or another entity, manually and/or automatically, based on, for example, frequency of the words in a particular message, origin of a message, a type of message, etc., or it may be compiled based on a frequency of words included in numerous prior (historical) messages received at the support engine 118, etc. In addition, multiple different stop lists may be compiled, each applicable to a different category or type of support message. In one embodiment, term frequency-inverse document frequency (TF-IDF) is employed on all of the terms/words that appear in all of the received support messages, by the support engine 118, to identify words to be included in the predefined stop list (or to generate multiple different predefined stop lists). For example, for a set of messages including 7,500 terms, the terms are organized (by TF-IDF score) in increasing order. Then, the top 500 of the organized terms (or a different number of terms) are submitted for review by customer service personnel of the payment service provider 106 (or of other entities), for example, who decide if the terms should be included or excluded from the predefined stop list. This permits the customer service personnel, or other, to provide input to the processing of support messages.

The at least one predefined list of words may also (or alternatively) include a predefined keep list, used by the support engine 118 for “keeping” or preserving words in the support message. Here, the words are preserved in the message, even if included in a predefined stop list as described above. For example, the support engine 118 may define a keep list, per message, as the words included in the subject text of the message. Generally, the subject text is the customer's first indication of the issue with the payment network 100, and on this basis, in some embodiments, the words of the subject text may be preserved even if frequently used. Nonetheless, in other examples, words included in the subject text, like words in the body text, may be subject to removal based on a predefined stop list. Generally, the predefined keep list is compiled manually and/or automatically, and based on one or more criteria, such as, for example, the occurrence of a related word in the body text of the message, etc.

With continued reference to FIG. 3, as a further part of normalizing the support message at 306, the support engine 118 removes, at 316, white spaces in the message, including carriage returns, multiple spaces, etc. However, a single space may be preserved between words in the support message to delineate between the different words (but this is not required). In the example of FIG. 4, the carriage returns are removed after the words “there,” at 416, “today?” at 418, and “issue?” at 420, among others. After 316 in the method 300, the support engine 118 converts the text in the message to a common case, at 318, either uppercase or lowercase. In the example of FIG. 4, the text is converted to lowercase, e.g., at 422, etc., in processing from the intermediate message 404 to the normalized message 406.

While normalization of the message 306 is described herein, at 308-318, in connection with the exemplary method 300, it should be appreciated that the same or different techniques (or different orders of techniques 308-318) of normalizing the support message may be employed in other embodiments, so that the message is suitable for further processing as described herein. Additionally, it should be appreciated that more or less normalization techniques may be employed in other embodiments, depending, for example, on the further processing to be performed on the support message. In at least one embodiment, normalization of the support message is even omitted.

With that said, after normalizing the message, the support engine 118 assigns a score to the support message, at 320, and stores the assigned score in memory 204 of computing device 114 associated with the payment service provider 106. In particular in the method 300, the support engine 118 assigns a score vector to the support message, which includes multiple scores, i.e., a score associated with (or assigned to) at least some of the individual words included in the normalized message. In some embodiments, all words in a support message are each assigned a score, with the group of scores for the message then forming the score vector. In other embodiments, however, less than all words in a support message are assigned a score (as part of forming the score vector).

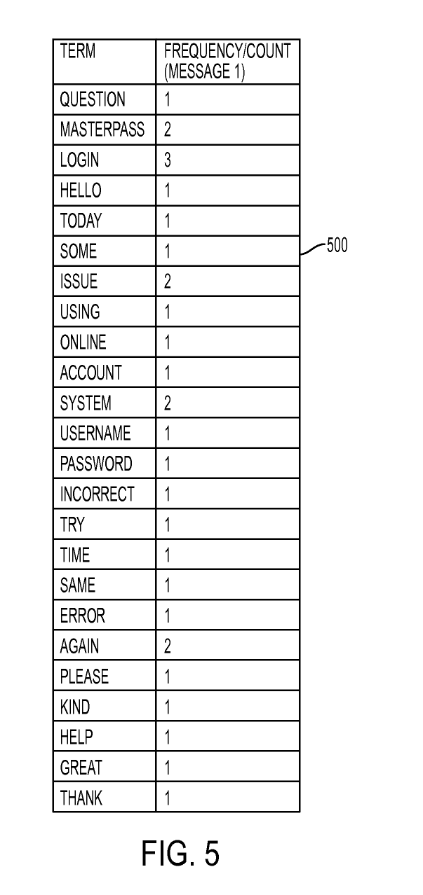

FIG. 5 illustrates an example world matrix 500 for the normalized support message 406 of FIG. 4. As shown, the score for each word in the normalized support message 406 is arranged into the word matrix 500. Although only scores for the example normalized support message 406 are included in the word matrix 500, it should be appreciated that other support messages may be represented in the matrix 500 in additional columns, with additional words added as necessary to provide an accurate score vector of the additional support messages. For example, for 123 support messages, having a total of 456 unique words in all of the normalized messages together, a word matrix will have a size of 123×456. Here, each column of the matrix 500 would then represent one of the multiple support messages, and each row would then represent scores in the different support messages for the particular words. Further, each support message would then have a score vector in the context of the matrix 500. As should be appreciated, by use of a common matrix across the multiple support messages, score vectors for the messages may be more easily compared.

In the word matrix 500 of FIG. 5, the scores represent the term-frequency scores for each word in the normalized message 406. As such, the score vector for the normalized message 406 is (1,2,3,1,1,1,2,1,1,1,2,1,1,1,1,1,1,1,2,1,1,1,1,1). This score vector may be changed or altered, as desired, for example, depending on ordering of the words in the matrix 500, etc. Further, in this example, while the number of occurrences of the words in the message 406 is directly indicative of the word scores (and the resulting score vector) for the message 406, other criteria may be used to assign scores, per word or otherwise, in other embodiments. Often, however, the scores are associated with the frequency of the words in the particular message being evaluated, either directly or indirectly. In one or more embodiments, the support engine 118 may further employ principal component analysis (PCA) to the score vector in the matrix 500 in order to reduce dimensionality. PCA is an orthogonal transformation, which transforms correlated variables (i.e., the occurrence of terms in normalized support messages, etc.) into linearly uncorrelated variables. Each is called a principal component. The support engine 118 then operates on the first ‘K’ principal components, based on the variance.

In other embodiments, score vectors may be assigned to normalized support messages (or other messages) based on a type of algorithm to be used in assigning predictive labels to the messages and/or in identifying response messages, as described below. In these embodiments, the score vectors, for example, may include continuous values, or discrete scores, in binary values. In addition, the score vectors may be subject to weighting based on one or more condition, including, for example, word frequency, etc. Further, while the score vectors are based on term frequencies, the support engine 118 may also assign score vectors based on TF-IDF or binary weighting schemes. Term frequency, as described above, includes the frequency at which a term appears in a support message. Binary weighting includes identifying a score in the vector as either “0” or “1”, where the “0” indicates the word is not present in the message and the “1” indicates the word is present in the message. TF-IDF, as used herein, includes a scheme (e.g., a weighting scheme), in which TF is the number of times a term is present in a message divided by the total number of terms in the message, and IDF is the logarithm of the total number of support messages (over a predefined interval) divided by the total number of support messages including the term. For example, one support message, in a group of 10 million support messages, includes 100 words, in which the word “login” appears 3 times. In the 10 million messages, 1,000 if the messages include the word “login.” The TF is 0.03 (i.e., 3/100), and the IDF is 4.0 (i.e., log(10,000,000/1000)). Thus, the TF-IDF is 0.12 (i.e., 0.03×4). In this example, the score vector for the support message would be 0.12, as corresponding to the word “login.” Additional score vectors may similarly be calculated for the support message, for one or more of the other words in the message.

In any case in the method 300, once the score vector is assigned to the normalized support message, the support engine 118 identifies a response message, at 322, based on the score vector. In particular, the support engine 118 searches in a data structure 324, which includes a plurality of reference score vectors, for a score vector that matches (or substantially matches) within a predefined threshold. In some embodiments, the match represents an identical match between the score vector assigned to the normalized support message and a score vector in the data structure 324 (where the identical match indicates the threshold is satisfied). In other embodiments, the match represents a substantial match between the score vector assigned to the normalized support message and a score vector in the data structure 324 (e.g., the score vector is within the predefined threshold of a score vector in the data structure 324 on a per score basis, or a per score vector basis, etc.). Examples of substantial matches will be provided hereinafter. The predefined threshold, for example, is generally determined through empirical iterations of support messages with known responses. Broadly, the data structure 324 includes a plurality of support messages, to which manual processes have been employed to assign labels and/or response messages. A first set of these messages, i.e., reference support messages, are processed according to the steps described above for method 300. The score vectors for these messages are then associated with the appropriate response messages in the data structure 324 (which are assigned to the support messages manually). Then, the steps of the method 300, through step 322, are completed for a second set of the messages, with the support engine 118 identifying response messages from the data structure 324 based on matching ones of the score vectors for the second set of messages to the score vectors for the first set of messages (i.e., the reference support messages), based on some predefined threshold. The identified responses for the second set of messages are then compared with the manually assigned responses for the first set of messages. As needed, the steps may be repeated, and the predefined threshold may be adjusted, so that the identified responses to the second set of messages are altered, as appropriate, to match the identified responses for the first set of messages. When the support engine 118 yields a sufficient success rate for the reference score vectors and one or more predefined thresholds, the support engine 118 may be further employed as described herein and below.

In some embodiments, cosine similarity metrics may be used to determine matches between (and compare) score vectors assigned to normalized support messages and reference score vectors associated with response messages (e.g., stored in data structure 324, etc.). The results are then evaluated in view of one or more desired predefined thresholds, for example, determined as described above (e.g., through empirical iterations, etc.). However, it should be appreciated that any number of different matching techniques may be used to compare a score vector for a support message to a score vector of one or more reference messages.

In addition, in some embodiments, the following cosine similarity measure may be employed:

$$cos θ = \frac{A \times B}{‖ A ‖ ‖ B ‖} = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}} \qquad ( 1 )$$

where “cos θ” represents the match value (on a range from −1 to +1, for example, where +1 would essentially represent an identical match); “A” represents the score vector assigned to the normalized support message; and “B” represents the reference score vector (to which the score vector assigned to the normalized support message is compared).

In one example application, a score vector of (1, 4, 1, 2, 4, 2, 1, 1, 1, 1, 4) is assigned to a normalized support message (e.g., via the method 300, etc.). As part of determining the appropriate response message, the support engine 118 compares the score vector to reference score vector (1, 4, 2, 2, 4, 2, 1, 1, 1, 1, 4) (among others), using equation (1), for example, to determine if the score vector assigned to the support message matches the reference score vector. In so doing, the support engine 118 determines that a match value for cos θ is 0.9924. In this example, a match is considered substantially matching (or as satisfying a predefined threshold), when the match value is greater than a threshold value of about 0.7 (e.g., as determined through various empirical interactions, etc.). As such, the value calculated for cos θ of 0.9924 is greater than 0.7, indicating that the two score vectors are considered a match.

In another example application, a score vector of (1, 0, 3, 1, 2) is assigned to a normalized support message (e.g., via the method 300, etc.). As part of determining the appropriate response message, the support engine 118 compares the score vector to reference score vector (0, 0, 1, 0, 1) (among others), using equation (1), for example, to determine if the score vector assigned to the support message matches the reference score vector. In so doing, the support engine 118 determines that a match value for cos θ is 0.9. In this example, a match is again considered substantially matching (or as satisfying a predefined threshold), when the match value is greater than the threshold value of about 0.7. As such, the value calculated for cos θ of 0.9 is greater than 0.7, indicating that the two score vectors are considered a match.

In still another example application, a score vector of (−1, 0, −3, −1, 2) is assigned to a normalized support message (e.g., via the method 300, etc.). As part of determining the appropriate response message, the support engine 118 compares the score vector to reference score vector (0, 0, 1, 0, 1) (among others), using equation (1), for example, to determine if the score vector assigned to the support message matches the reference score vector. In so doing, the support engine 118 determines that a match value for cos θ is −0.1826. In this example, a match is again considered substantially matching (or as satisfying a predefined threshold), when the match value is greater than the threshold value of about 0.7. As such, the value calculated for cos θ of −0.1826 is less than 0.7, indicating that the two score vectors are not considered a match.

In some embodiments, the support engine 118 may match more than one reference message, when, for example, the score vectors match according to the threshold employed by the support engine 118. In such embodiments, the support engine 118 selects a close match (e.g., a best match, etc.), based on the techniques employed to match the message, and/or identifies/communicates some or all of the matching messages and/or associated response messages to customer service personnel for evaluation. In the later instance, the customer service personnel may then select one or more of the response messages to be transmitted to the customer, as describe below.

In some embodiments, response messages may include predictive labels, which describe, briefly, issues and/or questions raised in the original support messages. The predictive labels may be used in one or more ways, by customer service personnel, to verify and/or check response messages, regularly or at certain regular or irregular intervals, to confirm performance of the support engine 118. The response messages also generally include predefined solutions for the issues and/or questions (e.g., videos, links to videos/documents, webpages, self-help instructions, blogs, etc.) based on, at least in part, prior manual analysis of the reference messages and/or continued review of support messages processed according to the automated methods herein, for example, by the support engine 118. Table 1 illustrates an example listing of 10 labels that may be included with response messages, and which may be identified by the support engine 118. As shown, the first column includes a response label designation, the second column includes a predictive label, and the third column includes a content included with the corresponding response message.

TABLE 1
Issue Classification Labels and their Responses

| | | |
|---|---|---|
| Label 1 | Product 1/Issue 1/Action 1 | Video Tutorial 1 |
| Label 2 | Product 1/Issue 2/Action 2 | User Manual 2 |
| Label 3 | Product 2/Issue 3/Action 1 | Video Tutorial 3 |
| Label 4 | Product 3/Issue 4/Action 2 | URL to solution |
| Label 5 | Product 3/Issue 5/Action 2 | Video Tutorial 4 |
| Label 6 | Product 3/Issue 1/Action 1 | User Manual 3 |
| Label 7 | Product 3/Issue 2/Action 3 | Video Tutorial 5 |
| Label 8 | Product 3/Issue 3/Action 1 | User Manual 1 |
| Label 9 | Product 3/Issue 6/Action 3 | Video Tutorial 2 |
| Label 10 | Product 4/Issue 1/Action 1 | URL to solution |

Further, in some embodiments, the response messages are identified by the support engine 118 (e.g., at 322 in method 300, etc.) based on, in part, information about the customer. Specifically, for example, when a customer is known to the payment service provider 106 to subscribe to particular features of the payment network 100, the support engine 118 may employ the identity of the customer from whom the support message was received to limit the search in the data structure 324. When the customer is consumer 116, for example, the support engine 118 may identify the consumer 116 as having a digital wallet supported by the payment service provider 106, and then limit the categories of response messages to those related to digital wallet features. It should be appreciated that other criteria may be employed, by the support engine 118 or the payment service provider 106, to identify response messages for particular support messages or for particular customers, and/or to provide efficiency in the identification of response messages.

With reference again to FIG. 3, upon identifying the response message, the support engine 118 automatically transmits, at 326, the identified response message to the customer from whom the support message was received (after translating the language, in some embodiments, if necessary). The response message generally includes at least one instruction related to the issue included in the support message. The at least one instruction will be specific to the issue, and will provide one or more solutions for the issue. Any suitable format may be used to convey this information to the customer, either directly in the response message, or through content linked to the response message. For example, the response message may include, without limitation, a video tutorial relating to the issue indicated in the support message, a user manual relating to the issue indicated in the support message, a link (e.g., a URL, etc.) to a written description relating to the issue indicated in the support message, and/or a link to a video description relating to the issue indicated in the support message.

As can be seen, the payment networks and methods of the present disclosure provide various advantages in connection with processing support messages to payment networks. Historical support messages, and the support personnel intervention with those support messages, are utilized, based on similarities with current issues in the payment network, to recommend solutions, instructions, or courses of action for particular issues in the payment network, thereby providing for more efficient use of the support personnel.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It should be appreciated that one or more aspects of the present disclosure transform a general-purpose computing device into a special-purpose computing device when configured to perform the functions, methods, and/or processes described herein

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving a message from a customer of the payment network, the message including text related to an issue with one or more features of the payment network, (b) normalizing the text of the message; (c) assigning a score vector to the normalized message, the score vector indicative of a number of occurrence of multiple words in the normalized message; (d) identifying a response message for the support message based on the score vector; and (e) transmitting the identified response message to the customer.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “connected to,” or “coupled to” another element, it may be directly on, connected or coupled to the other element, or intervening elements may be present. In contrast, when an element is referred to as being “directly on,” “directly connected to,” or “directly coupled to” another element, there may be no intervening elements present. As used herein, the term “and/or” includes any and all combinations of one or more of the associated listed items.

What is claimed is:

1. A computer-implemented method of processing support messages related to one or more features of a payment network, the method comprising:
receiving a support message from a customer of the payment network, the support message including text related to an issue with one or more features of the payment network;
normalizing, by a computing device, the text of the support message;
assigning, by the computing device, a score vector to the normalized support message, the score vector indicative of a number of occurrences of multiple words in the normalized support message;
identifying, by the computing device, a response message for the support message based on the score vector; and
transmitting the identified response message to the customer.

2. The computer-implemented method of claim 1, wherein the support message includes subject text and body text; and
wherein normalizing the support message includes merging the subject text and the body text into the text of the support message.

3. The computer-implemented method of claim 2, wherein normalizing the support message further includes stemming words included in the merged text of the support message.

4. The computer-implemented method of claim 1, wherein normalizing the support message includes, for each of multiple words in the text of the support message, removing the words when said words are included in a predefined list, except when said words are included in a subject text of the support message.

5. The computer-implemented method of claim 4, wherein normalizing the support message further includes one or more of:
purging the text of the support message of numeric characters, punctuation characters, and special characters, whereby only alphabetic characters remain in the text of the support message; and
converting alphabetic characters in the text of the support message to a common case character.

6. The computer-implemented method of claim 1, wherein identifying the response message includes matching, by the computing device, the score vector to a reference score vector associated with said response message.

7. The computer-implemented method of claim 1, wherein identifying the response message for the support message includes:
searching, in a data structure, for the score vector assigned to the support message, the data structure including a plurality of reference score vectors, each reference score vector associated with a response message; and
when the score vector assigned to the support message substantially matches one the plurality of reference score vectors, identifying the response message associated with said matching reference score vectors.

8. The computer-implemented method of claim 7, wherein the score vector assigned to the support message substantially matches one the plurality of reference score vectors when a match value of the score vector, when compared to the one of the plurality of reference score vectors, exceeds a predefined threshold value.

9. The computer-implemented method of claim 1, wherein the score vector includes a number of occurrences for each word in the normalized support message.

10. The computer-implemented method of claim 1, further comprising translating the support message from an original language to a predetermined language; and
translating the response message to the original language, prior to transmitting the response message to the customer.

11. A payment network for use in processing support messages from customers related to one or more features of the payment network, the payment network comprising:
a memory including a data structure comprising multiple reference score vectors, each of the multiple reference score vectors associated with a response message addressing an issue related to one or more features of a payment network; and
a support engine coupled to the memory, the support engine configured to:
normalize a support message, received from a customer, the support message indicating an issue with at least one feature of the payment network;
assign a score vector to the normalized support message based on a number of occurrences of multiple words in text of the normalized support message; and
when the assigned score vector substantially matches one of the reference score vectors in the data structure, transmit the response message associated with the matched one of the reference score vectors to the customer.

12. The payment network of claim 11, wherein the memory further includes a predefined list of words; and
wherein, in order to normalize the support message, the support engine is configured to remove each word included in the predefined list of words from the text of the support message.

13. The payment network of claim 11, wherein, in order to normalize the support message, the support engine is configured to:
remove all numeric characters, punctuation characters, and special characters from the text of the support message, such that only alphabetic characters remain; and/or
convert the text of the support message to a common case.

14. The payment network of claim 13, wherein, in order to normalize the support message, the support engine is configured to stem the text of the support message, whereby at least one word in the text of the support message is replaced with a root word for that at least one word.

15. The payment network of claim 13, wherein, in order to normalize the support message, the support engine is configured to:
remove punctuation characters and special characters, included in a predefined list, from the text of the support message; and/or
convert characters in the text of the support message to a common case.

16. The payment network of claim 11, wherein the assigned score vector substantially matches one of the reference score vectors in the data structure when a match value of the score vector, when compared to the one of the reference score vectors, exceeds a predefined threshold value.

17. A non-transitory computer readable media comprising computer-executable instructions that, when executed by at least one processor, cause the at least one processor to:
normalize a support message from a customer, the support message indicative of an issue encountered by the customer with one or more features of a payment network;
assign and store a score vector for the normalized support message, wherein the score vector includes a score for multiple words included in the normalized support message;
identify a response message, for the support message, based on the score vector; and
transmit the response message to the customer.

18. The non-transitory computer readable medium of claim 17, wherein the computer-executable instructions, when executed by the at least one processor, cause the at least one processor to identify the response message based on the score vector and a product associated with the customer.

19. The non-transitory computer readable medium of claim 17, wherein the computer-executable instructions, when executed by the at least one processor, cause the at least one processor, in order to normalize the support message, to:
remove special characters for the support message;
convert text of the support message to a common case;
for each word in the support message, remove the word when the word is included in a predefined stop list; and/or
stem text of the support message.

20. The non-transitory computer readable medium of claim 17, wherein the multiple words to which scores are assigned as part of the score vector include less than all words in the normalized support message.
